(19) United States
(12) Patent Application Publication
(10) Pub. No.: US 2009/0226795 A1
(43) Pub. Date: Sep. 10, 2009

(54) Fuel cell structure with external flow channels

(75) Inventors: Feng-Chang Chen, Jhongli City (TW); Yen-Yu Chen, Pingtung County (TW); Chi-Bin Wu, Taipei County (TW); Sz-Sheng Wang, Hsinchu City (TW)

Correspondence Address: Juan Carlos A. Marquez;c/o Stites & Harbison PLLC, 1199 North Fairfax Street, Suite 900, Alexandria, VA, 22314-1437, US

(73) Assignees: Chung- Hsin Electric; Machinery Manufacturing Corp.

(21) Appl. No.: 12/289,780

(22) Filed: Nov. 4, 2008

(30) Foreign Application Priority Data
Mar. 7, 2008 (TW) 097125083

(51) Int. Cl. H01M 8/04

(52) U.S. Cl. 429/34

(57) ABSTRACT

A fuel cell structure with external flow channels includes a fuel cell stack, a first external oxidant flow channel, a second external oxidant flow channel, a first external fuel flow channel, a second external fuel flow channel, a first external coolant flow channel and a second external coolant flow channel. Each external oxidant flow channel, each external fuel flow channel and each external coolant flow channel connect respectively with a plurality of internal oxidant flow channels, a plurality of internal fuel flow channels and a plurality of internal coolant flow channels of the fuel cell stack. The external flow channels simultaneously deliver oxidant, fuel and cooling fluid into the plurality of internal flow channels in order to increase efficiency of the fuel cell stack and remove waste heat from the fuel cell stack.

### BACKGROUND OF THE INVENTION

1. Technical Field

The present invention relates to a fuel cell structure with external flow channels, and more particularly, to a fuel cell structure with external flow channels applicable to fuel cells.

2. Description of Related Art

A fuel cell is a device for converting chemical energy into electric energy and features continuous generation of electricity as long as the fuel cell is supplied constantly with fuel needed in chemical reactions in the fuel cell. Fuel cells are advantageous in many ways. For example, they are highly efficient in generating electricity, free of pollution and capable of rapid fuel replenishment. As such, fuel cells have been an important technology in developing green energy. Structurally speaking, a fuel cell includes a plurality of cathode and anode flow channels. Fuel is delivered continuously through the flow channels to sustain chemical reactions in the fuel cell and thereby generate electricity. Therefore, the design of flow channels in a fuel cell has direct impact on the efficiency of fuel delivery and is closely related to the fuel cell's performance.

U.S. Pat. No. 6,503,650B1 discloses a fuel cell system comprising a cell multilayer element formed by stacking a plurality of unit cells together, an oxidant channel unit and a fuel channel unit, wherein each of the unit cells has internal oxidant flow channels connected with the oxidant channel unit, and internal fuel flow channels connected with the fuel channel unit.

In the aforesaid U.S. Pat. No. 6,503,650B1 the oxidant channel unit is provided on an external surface of the cell multilayer element while the fuel channel unit is formed inside the cell multilayer element by the plurality of unit cells stacked together. Besides, a flow dividing device is required to connect the fuel channel unit with the internal fuel flow channels.

In the aforesaid U.S. patent, the oxidant channel unit and the fuel channel unit are particularly designed to prevent blockage of the supplying channels that lowers the efficiency of the fuel cell system. However, the fuel cell system still has the following disadvantages:

1. The shape of the fuel supplying channel, which is formed by stacking the plurality of unit cells together, will be affected if one of the unit cells is offset while being stacked. In that case, the efficiency of the entire fuel cell system will be compromised as a result.

2. Fuel fed into the unit cell must go through the flow dividing device to be uniformly distributed in the unit cell. In consequence, the fuel enters the unit cell at a reduced speed.

### BRIEF SUMMARY OF THE INVENTION

An objective of the present invention is to provide a fuel cell structure with external flow channels, wherein oxygen flow channels, fuel flow channels and coolant flow channels are provided outside a fuel cell stack. As each of the flow channels is independently provided outside the fuel cell stack, it is easier and more convenient to install the external flow channels and connect them with internal flow channels, allowing the internal and external flow channels to be positioned relative to one another with improved precision.

Another objective of the present invention is to provide a fuel cell structure with external flow channels, in which the fuel cell structure is capable of simultaneously delivering fuel, oxidant and cooling fluid to a plurality of internal flow channels, thereby increasing the speed of fuel delivery and effectively removing waste heat generated by a fuel cell stack.

In order to achieve these objectives, the present invention provides a fuel cell structure with external flow channels, wherein the fuel cell structure comprises: a fuel cell stack formed by stacking a plurality of unit cells together, each of the unit cells having a plurality of internal oxidant flow channels, a plurality of internal fuel flow channels and a plurality of internal coolant flow channels; a first external oxidant flow channel connected with a surface of the fuel cell stack so as to communicate with first ends of all the internal oxidant flow channels; a second external oxidant flow channel connected with a surface of the fuel cell stack so as to communicate with second ends of all the internal oxidant flow channels; a first external fuel flow channel connected with a surface of the fuel cell stack so as to communicate with first ends of all the internal fuel flow channels; a second external fuel flow channel connected with a surface of the fuel cell stack so as to communicate with second ends of all the internal fuel flow channels; a first external coolant flow channel connected with a surface of the fuel cell stack so as to communicate with first ends of all the internal coolant flow channels; and a second external coolant flow channel connected with a surface of the fuel cell stack so as to communicate with second ends of all the internal coolant flow channels.

The present invention can be implemented to achieve at least the following advantageous effects:

1. The external flow channels are designed to allow precise connection between the internal and external flow channels.

2. By omitting the conventional step of forming a common flow channel by stacking a plurality of unit cells together, the production time of the fuel cell can be reduced.

3. The external flow channels are connected and in communication with the internal flow channels of the fuel cell stack to enable simultaneous delivery of oxidant, fuel and cooling fluid into each of the unit cells, thereby increasing the efficiency of the fuel cell stack and rapidly removing waste heat generated by the fuel cell stack.

4. The external flow channels are designed to increase a reaction area of electrodes in the fuel cell stack, thereby enabling the fuel cell stack to generate electricity more efficiently.

5. The flow channels provided outside the fuel cell stack can be made of materials other than metal to reduce the production cost and weight of the fuel cell.

A detailed description of further features and advantages of the present invention is given below, so that a person skilled in the art is allowed to understand and carry out the technical contents of the present invention, and can readily comprehend the objectives and advantages of the present invention by reviewing the contents disclosed herein, the appended claims and the accompanying drawings.

### BRIEF DESCRIPTION OF THE SEVERAL VIEWS OF THE DRAWINGS

The invention as well as a preferred mode of use, further objectives and advantages thereof will be best understood by referring to the following detailed description of illustrative embodiments in conjunction with the accompanying drawings, wherein:

FIG. 1 is an exploded perspective view of a fuel cell structure with external flow channels according to an embodiment of the present invention;

FIG. 2 is an exploded perspective view of a unit cell according to the present invention;

FIG. 3A is a cross-sectional view taken along a line A-A in FIG. 1;

FIG. 3B is a cross-sectional view taken along a line B-B in FIG. 1;

FIG. 3C is a cross-sectional view taken along a line C-C in FIG. 1; and

FIG. 4 is an exploded perspective view of a fuel cell structure with external flow channels according to another embodiment of the present invention.

### DETAILED DESCRIPTION OF THE INVENTION

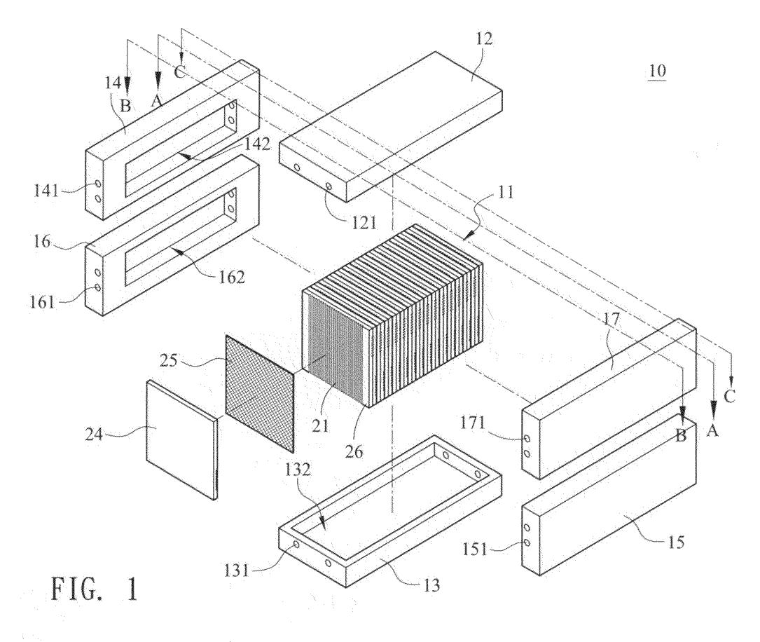

Referring to FIG. 1, a structure of a fuel cell 10 with external flow channels according to an embodiment of the present invention comprises a fuel cell stack 11, a first external oxidant flow channel 12, a second external oxidant flow channel 13, a first external fuel flow channel 14, a second external fuel flow channel 15, a first external coolant flow channel 16 and a second external coolant flow channel 17.

The fuel cell stack 11 is formed by stacking a plurality of unit cells 20 together. Each of the unit cells 20 has a plurality of internal oxidant flow channels 21, a plurality of internal fuel flow channels 22 and a plurality of internal coolant flow channels 23.

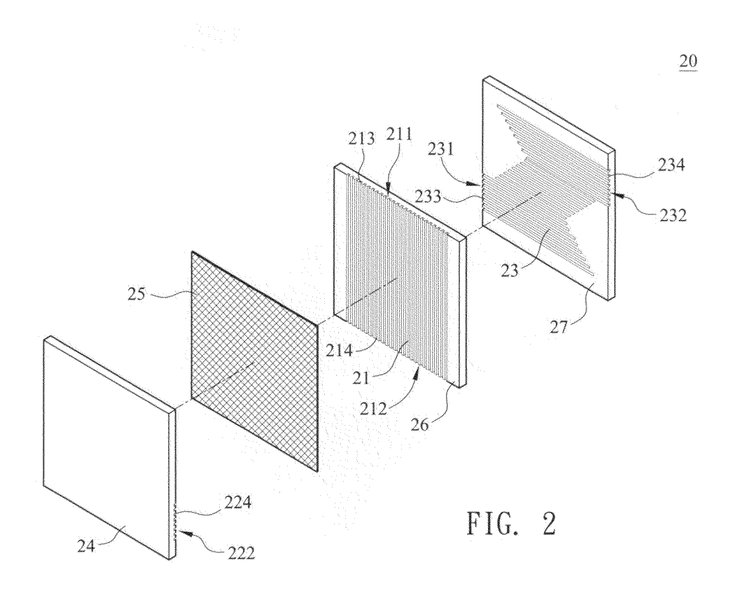

As shown in FIG. 2, each of the unit cells 20 comprises an anode flow channel plate 24 having the plurality of internal fuel flow channels 22, a membrane electrode assembly plate 25, a cathode flow channel plate 26 having the plurality of internal oxidant flow channels 21, and a coolant flow channel plate 27 having the plurality of internal coolant flow channels 23.

Each of the internal oxidant flow channels 21 is formed with a first end 211 and a second end 212 provided respectively with openings 213 and 214. Each of the internal fuel flow channels 22 is formed with a first end 221 and a second end 222 provided respectively with openings 223 and 224. Each of the internal coolant flow channels 23 is formed with a first end 231 and a second end 232 provided respectively with openings 233 and 234. In addition, the internal flow channels 22, 21 and 23 of the respective flow channel plates 24, 26 and 27 can be grate-like flow channels or serpentine flow channels.

The membrane electrode assembly plate 25 has at least one membrane electrode assembly. Generally, a membrane electrode assembly plate 25 comprises a gas diffusion layer, a cathode catalyst layer, an anode catalyst layer and an electrolyte layer. When oxidant and fuel flow respectively through the cathode flow channel plate 26 and the anode flow channel plate 24 flanking each membrane electrode assembly plate 25, electrochemical reactions take place at the cathode and anode of each membrane electrode assembly plate 25 so that electric current is generated in each unit cell 20.

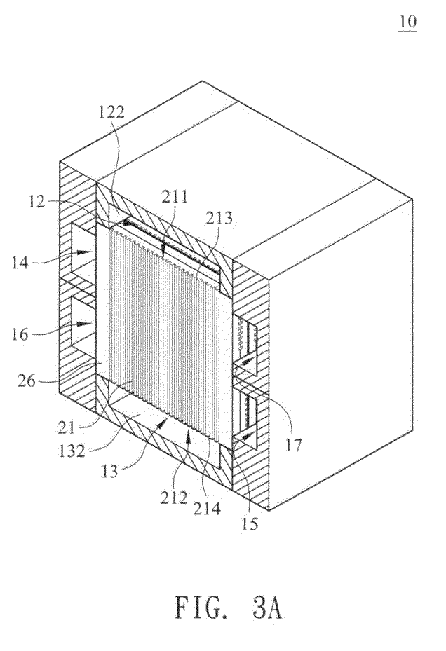

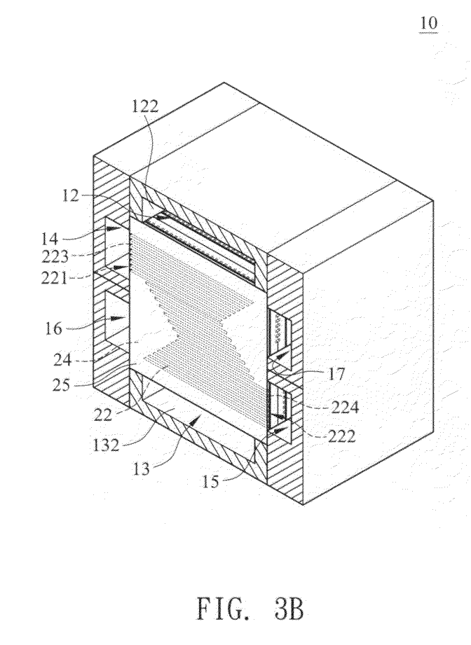

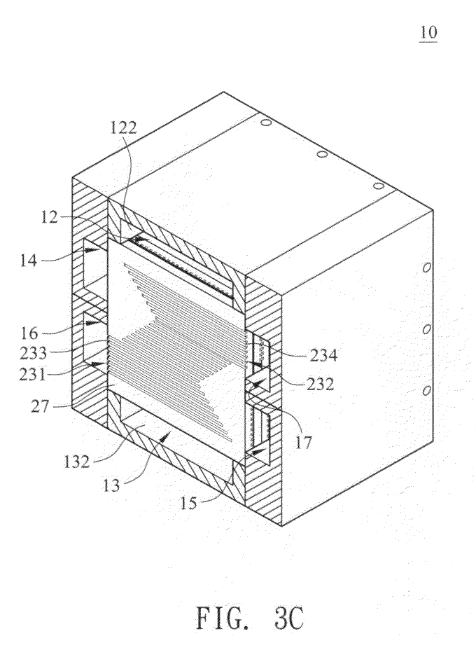

As shown in FIG. 3A, the first external oxidant flow channel 12 is connected with a surface of the fuel cell stack 11 so as to communicate with the first ends 211 of all the internal oxidant flow channels 21. The first external oxidant flow channel 12 has at least one first oxidant delivery hole 121 and a first oxidant delivery cavity 122, wherein the first oxidant delivery hole 121 is in communication with the first oxidant delivery cavity 122, which in turn is in communication with the first ends 211 of all the internal oxidant flow channels 21. Hence, the first external oxidant flow channel 12 can be used to supply oxidant, such as oxygen or air, into the fuel cell stack 11.

Referring again to FIG. 3A, the second external oxidant flow channel 13 is connected with a surface of the fuel cell stack 11 so as to communicate with the second ends 212 of all the internal oxidant flow channels 21. The second external oxidant flow channel 13 has at least one second oxidant delivery hole 131 and a second oxidant delivery cavity 132, wherein the second oxidant delivery hole 131 is in communication with the second oxidant delivery cavity 132, which in turn is in communication with the second ends 212 of all the internal oxidant flow channels 21. Therefore, the second oxidant delivery hole 131 of the second external oxidant flow channel 13 can be used to discharge unreacted oxidant. Alternatively, the second external oxidant flow channel 13 may also serve as an external flow channel for supplying oxidant into the fuel cell stack 11.

Referring now to FIG. 3B, the first external fuel flow channel 14 is connected with a surface of the fuel cell stack 11 so as to communicate with the first ends 221 of all the internal fuel flow channels 22. The first external fuel flow channel 14 has at least one first fuel delivery hole 141 and a first fuel delivery cavity 142, wherein the first fuel delivery hole 141 is in communication with the first fuel delivery cavity 142, which in turn is in communication with the first ends 221 of all the internal fuel flow channels 22. Hence, the first external fuel flow channel 14 can be used to supply fuel, such as hydrogen, into the fuel cell stack 11.

Referring again to FIG. 3B, the second external fuel flow channel 15 is connected with a surface of the fuel cell stack 11 so as to communicate with the second ends 222 of all the internal fuel flow channels 22. The second external fuel flow channel 15 has at least one second fuel delivery hole 151 and a second fuel delivery cavity 152, wherein the second fuel delivery hole 151 is in communication with the second fuel delivery cavity 152, which in turn is in communication with the second ends 222 of all the internal fuel flow channels 22. Therefore, the second fuel delivery hole 151 of the second external fuel flow channel 15 can be used to discharge unreacted fuel. Alternatively, the second external fuel flow channel 15 may also serve as an external flow channel for supplying fuel into the fuel cell stack 11.

Referring now to FIG. 3C, the first external coolant flow channel 16 is connected with a surface of the fuel cell stack 11 so as to communicate with the first ends 231 of all the internal coolant flow channels 23. The first external coolant flow channel 16 has at least one first coolant delivery hole 161 and a first coolant delivery cavity 162, wherein the first coolant delivery hole 161 is in communication with the first coolant delivery cavity 162, which in turn is in communication with the first ends 231 of all the internal coolant flow channels 23. Hence, the first external coolant flow channel 16 can be used to supply cooling fluid, such as a liquid coolant or air, into the fuel cell stack 11.

Referring again to FIG. 3C, the second external coolant flow channel 17 is connected with a surface of the fuel cell stack 11 so as to communicate with the second ends 232 of all the internal coolant flow channels 23. The second external coolant flow channel 17 has at least one second coolant delivery hole 171 and a second coolant delivery cavity 172, wherein the second coolant delivery hole 171 is in communication with the second coolant delivery cavity 172, which in turn is in communication with the second ends 232 of all the internal coolant flow channels 23. Therefore, the second coolant delivery hole 171 of the second external coolant flow channel 17 can be used to discharge the cooling fluid. Alternatively, the second external coolant flow channel 17 may also serve as an external flow channel for supplying the cooling fluid to the fuel cell stack 11.

While manufacturing the fuel cell 10 with the external flow channels, all the external flow channels 12, 13, 14, 15, 16 and 17 can be made of materials other than metal, such as plastic. Therefore, not only the production cost, but also the overall weight of the fuel cell 10 with the external flow channels can be reduced.

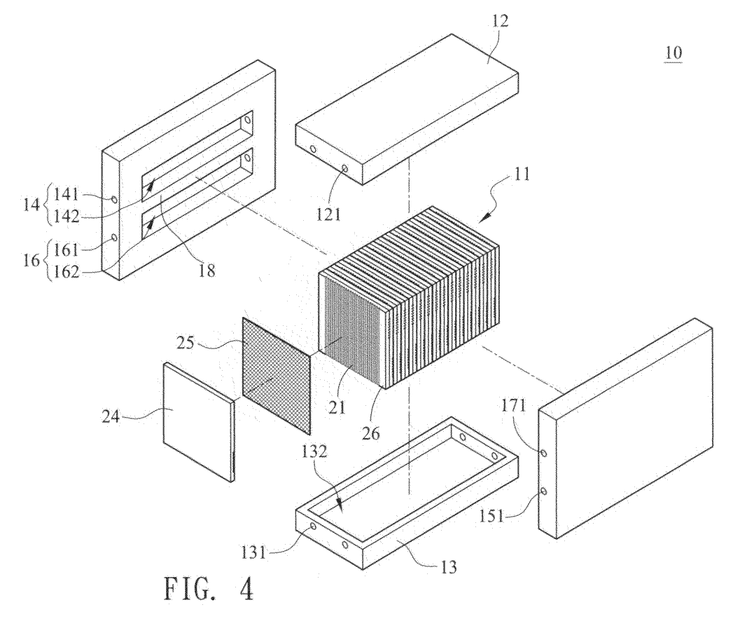

As shown in FIG. 4, if the first ends 221 of all the internal fuel flow channels 22 and the first ends 231 of all the internal coolant flow channels 23 are located on a same surface of the fuel cell stack 11, the first external fuel flow channel 14 and the first external coolant flow channel 16 may have an integrally formed structure divided by a partition 18. Similarly, if the second ends 222 of all the internal fuel flow channels 22 and the second ends 232 of all the internal coolant flow channels 23 are located on a same surface of the fuel cell stack 11, the second external fuel flow channel 15 and the second external coolant flow channel 17 may have an integrally formed structure divided by a partition 18.

According to the structure of the fuel cell 10 with the external flow channels, oxidant and fuel can be fed in, for example, through the first oxidant delivery hole 121 and the first fuel delivery hole 141, respectively.

Thereafter, the oxidant and fuel flow through the first external oxidant flow channel 12 and the first external fuel flow channel 14, respectively. Since the first oxidant delivery cavity 122 and the first fuel delivery cavity 142 are respectively in communication with the first ends 211 and 221 of all the internal oxidant flow channels 21 and internal fuel flow channels 22, the oxidant and the fuel are allowed to flow uniformly and simultaneously into the internal flow channels of each unit cell 20 via the openings 213 and 214 of all the internal oxidant flow channels 21 and all the internal fuel flow channels 22, respectively, without the help of an additional flow dividing device. Thus, the oxidant and the fuel can enter each unit cell 20 more speedily while the external flow channels increase a reaction area of the electrodes in the fuel cell stack 11, thereby enhancing the efficiency of the fuel cell stack 11.

After entering each unit cell 20, the oxidant and the fuel flow along the internal oxidant flow channels 21 of the cathode flow channel plate 26 and the internal fuel flow channels 22 of the anode flow channel plate 24, respectively, so that the membrane electrode assembly plate 25 is supplied with the oxidant and the fuel and starts electrochemical reactions to generate electricity. Finally, unreacted oxidant flows through the openings 214 of the internal oxidant flow channels 21 and exits via the second oxidant delivery hole 131, while unreacted fuel flows through the openings 224 of the internal fuel flow channels 22 and exits via the second fuel delivery hole 151.

The structure of the fuel cell 10 with the external flow channels also allows an alternative way of oxidant and fuel delivery, in which oxidant and fuel are fed in through the second oxidant delivery hole 131 and the second fuel delivery hole 151, respectively, whereas unreacted oxidant and fuel are discharged through the first oxidant delivery hole 121 and the first fuel delivery hole 141, respectively.

The structure of the fuel cell 10 with the external flow channels may comprise a liquid-cooled fuel cell stack or a gas-cooled fuel cell stack. When the structure of the fuel cell 10 with the external flow channels comprises a liquid-cooled fuel cell stack, the first external coolant flow channel 16 and the second external coolant flow channel 17 are liquid-cooling external flow channels. Similarly, when the structure of the fuel cell 10 with the external flow channels comprises a gas-cooled fuel cell stack, the first external coolant flow channel 16 and the second external coolant flow channel 17 are gas-cooling external flow channels.

The structure of the fuel cell 10 with the external flow channels is cooled by a cooling liquid or gas entering through the first coolant delivery hole 161 of the first external coolant flow channel 16 and exiting through the second coolant delivery hole 171 of the second external coolant flow channel 17. Alternatively, the cooling liquid or gas may be fed in through the second coolant delivery hole 171 and discharged through the first coolant delivery hole 161.

Since the first coolant delivery cavity 162 of the first external coolant flow channel 16 and the second coolant delivery cavity 172 of the second external coolant flow channel 17 are respectively in communication with the first ends 231 and the second ends 232 of all the internal coolant flow channels 23, the cooling liquid or gas will circulate through all the internal coolant flow channels 23 and thus remove waste heat generated from the electrochemical reactions in the fuel cell stack 11, thereby protecting the fuel cell stack 11 from overheating.

The disclosed embodiments are intended to illustrate features of the present invention so as to enable a person skilled in the art to understand and implement the contents of the present invention. The embodiments, however, are not intended to limit the scope of the present invention. Therefore, all equivalent modifications or changes which do not depart from the spirit of the present invention should be encompassed by the appended claims.

1. A fuel cell structure with external flow channels, comprising:
a fuel cell stack, formed by stacking a plurality of unit cells together, each said unit cell having a plurality of internal oxidant flow channels, a plurality of internal fuel flow channels and a plurality of internal coolant flow channels;
a first external oxidant flow channel, connected with a surface of the fuel cell stack so as to communicate with first ends of all the internal oxidant flow channels;
a second external oxidant flow channel, connected with a surface of the fuel cell stack so as to communicate with second ends of all the internal oxidant flow channels;
a first external fuel flow channel, connected with a surface of the fuel cell stack so as to communicate with first ends of all the internal fuel flow channels;
a second external fuel flow channel, connected with a surface of the fuel cell stack so as to communicate with second ends of all the internal fuel flow channels;
a first external coolant flow channel, connected with a surface of the fuel cell stack so as to communicate with first ends of all the internal coolant flow channels; and
a second external coolant flow channel, connected with a surface of the fuel cell stack so as to communicate with second ends of all the internal coolant flow channels.

2. The fuel cell structure of claim 1, wherein the first external oxidant flow channel has at least one first oxidant delivery hole and a first oxidant delivery cavity in communication with the first ends of all the internal oxidant flow channels.

3. The fuel cell structure of claim 1, wherein the second external oxidant flow channel has at least one second oxidant delivery hole and a second oxidant delivery cavity in communication with the second ends of all the internal oxidant flow channels.

4. The fuel cell structure of claim 1, wherein the first external fuel flow channel has at least one first fuel delivery hole and a first fuel delivery cavity in communication with the first ends of all the internal fuel flow channels.

5. The fuel cell structure of claim 1, wherein the second external fuel flow channel has at least one second fuel delivery hole and a second fuel delivery cavity in communication with the second ends of all the internal fuel flow channels.

6. The fuel cell structure of claim 1, wherein the first external coolant flow channel has at least one first coolant delivery hole and a first coolant delivery cavity in communication with the first ends of all the internal coolant flow channels.

7. The fuel cell structure of claim 1, wherein the second external coolant flow channel has at least one second coolant delivery hole and a second coolant delivery cavity in communication with the second ends of all the internal coolant flow channels.

8. The fuel cell structure of claim 1, wherein one of the first ends and the second ends of all the internal fuel flow channels and one of the first ends and the second ends of all the internal coolant flow channels are located on a same surface of the fuel cell stack, and the first external fuel flow channel and the first external coolant flow channel have an integrally formed structure divided by a partition.

9. The fuel cell structure of claim 1, wherein one of the first ends and the second ends of all the internal fuel flow channels and one of the first ends and the second ends of all the internal coolant flow channels are located on a same surface of the fuel cell stack, and the second external fuel flow channel and the second external coolant flow channel have an integrally formed structure divided by a partition.

10. The fuel cell structure of claim 1, wherein the first external coolant flow channel and the second external coolant flow channel are liquid-cooling external flow channels.

11. The fuel cell structure of claim 1, wherein the first external coolant flow channel and the second external coolant flow channel are gas-cooling external flow channels.
